(19) United States
(12) Patent Application Publication
(10) Pub. No.: US 2018/0277268 A1
(43) Pub. Date: Sep. 27, 2018

(54) A METHOD FOR THE MANUFACTURE OF POWDER-FILLED SHAPED BODIES, SHAPED BODIES FOR INTRODUCTION INTO A COMMERCIAL NUCLEAR POWER REACTOR AND THE USE THEREOF

(71) Applicant: Areva GmbH, Erlangen (DE)

(72) Inventors: Franz Strohmer, Bamberg (DE); Oliver Arndt, Taunusstein (DE); Leila Jaafar, Erlangen (DE)

(21) Appl. No.: 15/525,115

(22) PCT Filed: Nov. 12, 2015
(86) PCT No.: PCT/EP2015/076380

§ 371 Date: May 8, 2017

(30) Foreign Application Priority Data
Nov. 13, 2014 (DE) 102014116572.1

(51) Int. Cl. G21C 17/108; G21G 1/02; G21C 19/20

(52) U.S. Cl. CPC G21C 17/108; G21C 3/20; G21C 19/202; G21G 1/02

(57) ABSTRACT

To manufacture shaped bodies (10) filled with powder (22) for introduction into the reactor core of a commercial nuclear power reactor a plate made of a metal and/or metalloid is provided with one or more blind holes (14), the blind holes (14) are filled with powder (22), the blind holes (14) filled with powder (22) are reversibly sealed and shaped bodies are cut from the plate so that each blind hole (14) filled with powder (22) is surrounded by a shell made of a metal or metalloid. The powder-filled shaped bodies (10) are used in a ball measuring system for commercial nuclear power reactors and/or for the generation of radionuclides in said reactors.

The invention relates to powder-filled shaped bodies for introduction into a commercial nuclear power reactor, a method for their manufacture, and the use of shaped bodies in a ball measuring system for commercial nuclear power reactors and for the generation of radionuclides.

Radionuclides have a wide range of use for medical applications in the diagnosis and treatment of diseases. Radionuclides are unstable nuclides of an element. In particular short-life radionuclides can be generated by nuclear reactions, especially by neutron capture and, as appropriate, subsequent decay reactions. Usually, radionuclide generation is elaborate and expensive as the material has to be introduced into the neutron flux of a research reactor. However, irradiation sites in research reactors are limited and thus expensive. In addition, a variety of research reactors will be shut down in the future for reasons of age; that is why a further tightening of irradiation sites in research reactors worldwide is to be expected.

On the other hand, systems for measuring neutron flux density within commercial nuclear power reactors, hereinafter referred to as “ball measuring systems”, are known in which a hollow measuring tube in the reactor core is filled with balls of a known composition, and the balls are exposed to neutron radiation in the reactor core for a certain period of time. After this period has elapsed the balls are again removed from the measuring tube, e.g. by compressed air, and the degree of activation of the individual balls is determined, thus providing a precise image of the neutron flux and neutron density distribution in the reactor. For example, such a ball measuring system is described in DE 1 294 575 A.

Within the reactor core high pressures and high temperatures, for example up to 400° C., prevail, and the measuring balls have to be dimensionally stable under these conditions and must not undergo chemical reactions. In addition, the measuring balls have to have precise dimensions as, on the one hand, their shape and size influence measuring accuracy and, on the other hand, obstruction of the measuring tube is to be excluded. Commercially available systems, for example, use balls made of carbon steel of a diameter of 1.6 mm.

From US 2013/0170927 A1 it is known to load the measuring tube of a neutron detector passing through the reactor core with irradiation bodies and to pass the irradiation bodies through the reactor core, with the irradiation bodies converted into radionuclides by neutron bombardment. The irradiation bodies may be ball-shaped and made of the material to be converted. According to another embodiment the irradiation bodies may have a hard external shell and can be filled with a solid, a liquid or a gas from which the desired radionuclides are to be generated. However, a manufacturing method for the irradiation bodies is not described.

For the irradiation bodies to withstand the conditions in the reactor core including high pressures and high temperatures and to resist the forces occurring in a ball measuring system as well as to exhibit the required abrasion resistance, the bodies passed through the measuring tube need to have high strength, temperature resistance and chemical inertness. These requirements are not met by most of the materials suitable for the generation of radionuclides, especially as changes of the chemical and physical properties of the irradiation bodies occur as a result of the neutron bombardment.

For example, for the generation of lutetium-177, it is not possible to use ytterbium-176-oxide in the form of oxidic balls as these balls would be too brittle and burst when injected into the measuring system. Metallic ytterbium balls cannot be used either, as ytterbium in its metallic form is very soft and the ytterbium balls would deform when injected into the ball measuring system and obstruct the system. Likewise, for a variety of other radionuclides there are no starting materials available from which complete metallic balls with the required chemical and mechanical resistance could be produced.

Thus the object of the invention is to provide shaped bodies, and an economical method for their manufacture, that can also be introduced into ball measuring systems of traditional commercial nuclear power reactors used for commercial energy generation and that allow the generation of the desired radionuclides for industrial, scientific and in particular medical applications.

To this end, powder-filled shaped bodies according to the present invention that are to be introduced into a commercial nuclear power reactor are manufactured by:
providing a plate made of a metal and/or metalloid with one or more blind holes,
filling the blind holes with powder,
closing the powder-filled blind holes reversibly and
cutting shaped bodies from the plate to form a powder-filled blind hole surrounded by a shell made of a metal and/or metalloid.

The invention thus provides shaped bodies with a stable shell, in which various radionuclide precursors can be introduced, with the shell having the necessary chemical and mechanical stability so that the shaped bodies can be introduced into the reactor core by means of a ball measuring system. In the reactor core, the powder sealed in the shaped body can then be converted into the desired radionuclide by a nuclear chemical reaction. In addition, the inclusion of the powder in the shaped body allows safe protection against contamination of the radionuclide to be generated. Manufacture of the shell and removal of the radionuclide generated may be performed by use of established automated methods on economically favorable conditions. This way, in particular short-life radionuclides can be customized. This allows the generation of radionuclides without the need to interrupt reactor operation.

Instead of manufacturing individual shaped bodies from solid matter, or hollow balls that are subsequently filled, the shaped bodies according to the present invention are cut from a planar solid material after filling the blind holes subsequently present in their interior. This allows automated filling and manufacture of the shaped bodies.

As a material for the plate, metals and metalloids as well as their alloys can be used, e.g. steels such as high-grade steel, chrome steel, carbon steel, heat-treated carbon steel as well as zirconium, silicon, magnesium, aluminum, molybdenum or an alloy or mixture based on one or more of these materials including an alloy of one or more of these materials with carbon. Duralumin alloys such as AlSiMg are particularly preferred.

It is understood by those skilled in the art that, in the case of alloys, apart from the primary elements other metals, metalloids or non-metals such as calcium, boron, nitrogen or phosphorus can be present as alloying elements in common proportions. The materials mentioned readily meet the requirements for dimension stability, quality and toughness of measuring balls in the known systems to determine neutron flux in the nuclear reactor core.

It is preferred to use materials with low neutron absorption in order to achieve an intense neutron flux through the powder in the interior of the shaped body. In addition, inherent activation of such materials in the neutron field is too low, resulting in a very low inherent radiation by activation of the material of the shell.

However, in single cases, it is conceivable to use the shaped body after irradiation in the reactor core to generate a radionuclide.

Since the manufacture of the shaped bodies is based on a planar plate made of a metal and/or metalloid from which the shell of the shaped body is formed, all mechanical, chemical or procedural steps right up to the sealing of the shaped bodies can be performed directly on the plate. The advantage of this procedure is that all steps can be performed technically simultaneously for a plurality of shaped bodies to be manufactured. It is only in the last procedural step that the individual shaped bodies are cut from the plate, for example by CNC milling. Thus, the process has the advantage that all individual steps can be automated and a variety of chemically inert and sealed shaped bodies can be manufactured simultaneously and in parallel, making the manufacture of the shaped bodies very inexpensive.

Preferably, the thickness of the plate approximately corresponds to the exterior diameter of the shaped bodies to be manufactured.

The method according to the present invention can be easily implemented at a larger scale, in particular for shaped bodies with small diameters, allowing, for example, fast and accurate manufacture of shaped bodies with a diameter of a few millimeters, in particular with a diameter of about 1 to 3 mm.

Preferably, the shaped bodies are provided with a ball-like outer contour, although other shapes are also possible, for example ellipsoids or a disc or lens shape.

Preferably, the blind holes are drilled, with in particular the bottom of the blind holes formed as a concave curvature in order to maximize the powder filling quantity. Incorporation of the blind holes into the plate can also be performed as a fully automated procedural step.

Plate cuttings and thus material consumption can be minimized by hexagonal arrangement of the blind holes in the plate.

According to the present invention, as a starting material for the manufacture of the desired radionuclides, a powder can be used and introduced into the blind holes, having the advantage over gases or liquids to allow a prolonged dwelling time in the nuclear reactor core at high temperatures. For easier filling and accurate dosing the powder should be as finely ground and free-flowing as possible, and also keep flowability if exposed to temperatures of approximately 400° C. for a prolonged period of time. For example, the grain size of the powder can be from 1 μm to 100 μm. Preferably, when used, the materials used are of the highest chemical purity level possible, e.g. of purity levels “ultrapure”, “suitable for analysis” or higher.

According to a preferred embodiment, the blind holes, prior to being filled with the powder, are provided with a chemically inert coating. “Chemically inert” means that the powder does not react with the coating under the conditions prevailing in the nuclear reactor core. By means of the coating undesired chemical reactions of the powder with the material of the surrounding shell can be prevented, thus excluding contamination of the radionuclides generated.

The coating is preferably an oxide or a silicate. Coatings made of silicon oxide, titanium oxide, zirconium oxide, aluminum oxide or aluminosilicate are particularly preferred. The coating may be glass-like, thus ensuring good adherence on the material of the surrounding shell.

Preferably, the coating is formed by anodic oxidation, in particular by anodizing. It is particularly preferred that the material contains aluminum and the coating is applied by anodizing.

The blind holes can preferably be filled with the powder by means of known dosing devices such as series pipettes known from the pharmaceutical industry. Thus, this procedural step can also be fully automated.

In a first preferred process, for the shaped body to be reversibly sealed, the blind holes are provided with an internal thread.

After being filled with the powder, the blind holes can now be sealed by means of a closing element in the form of a screw to allow controlled opening to remove the powder after expiry of the dwelling time of the shaped body in the reactor core.

For sealing the aperture in a shaped body with a concave exterior wall, for example a ball or an ellipsoid, it is favorable to use a taper thread as the internal thread as well as a taper screw for closing.

Preferably, magnetic screws are used, making it easier to insert the screw and subsequently empty the shaped body.

In order to empty the shaped body and remove the powder from the cavity of the shaped body, the individual shaped bodies can be gripped by a magnetic tool, with the screw automatically aligning to the tool. A shaped body positioned this way can be fixed by a suitable gripping device while removing the magnetic screw in order to open the shaped body and expose the powder in its interior.

In a second preferred process, the blind holes are sealed with a closing element in the form of a stopper, which is clamped onto the wall of the blind hole. This variant saves the expenditure of opening and closing the screw connection.

For easy automation of this process it is preferred to use materials with different coefficients of thermal expansion for the stopper and the plate, selecting the diameter of the stopper in such a way that the stopper preferably seals the blind hole hermetically at room temperature (20° C.) or higher temperatures. Preferably, the material of the stopper has a higher coefficient of thermal expansion than the material of the plate or of the finished shaped body.

Preferably, the diameter of the blind holes is larger at their upper edge than in their lower section in which the powder is introduced. The diameter of the stopper is adapted to the diameter in the upper section of the stopper.

To seal the shaped body at least the stopper and, if necessary, the plate is cooled to a temperature below room temperature and cold shrunk. After cooling down the stopper and/or the plate the stopper can be easily inserted in the respective blind hole due to the reduced diameter of the stopper. If the plate and the stopper again reach room temperature or higher temperatures, the blind holes are tightly sealed by the stoppers. This process can also be easily automated.

To remove the stoppers from the blind holes the entire shaped bodies are again cooled to a temperature below room temperature for the clamp connection between the stopper and the blind holes to come loose. For example, the stoppers, together with the powder, may be automatically shaken out of the blind holes in a drum. Stopper and powder can be separated by screening.

In a third preferred embodiment the blind hole is sealed by a closing element made of a shape memory alloy having a first state in which it can be loosened from the blind hole and a second state in which it tightly seals the blind hole.

For sealing the blind hole, the closing element is preferably brought into its first state by cooling it to a first, low temperature of e.g. 10° C. or less and, for example, inserted into a radial groove running along the peripheral edge of the blind hole. When re-heated to a second, higher temperature, the closing element assumes its second state in which it engages radially into the groove, preferably filling it, and seals the blind hole.

To remove the powder from the shaped bodies these are at least cooled down to the first temperature, allowing the closing elements to assume their first state to be loosened from the shaped bodies.

All procedural steps regarding the filling and closing of the blind holes are preferably performed prior to cutting the individual shaped bodies from the plate.

Even all operations that may be necessary for shaping the closing elements are preferably performed as long as the shaped bodies are still linked via the plate to facilitate fixation. For example, the contour of the screw head can be processed to fit into the desired outer contour of the shaped body.

It is only in the last procedural step that the outer contour of the shaped body is completed and the shaped bodies are separated from each other.

For example, the shaped bodies can be cut from the plates by means of a milling tool or another suitable method. This procedural step can also be fully automated, for example by CNC milling, while forming the desired outer contour of the shaped bodies.

Preferably, the outer contour of the shaped bodies is a ball. However, the shaped bodies can also be manufactured in the form of ellipsoids, lenses or discs.

By selecting a suitable array of the blind holes in the plate the shaped bodies can be cut from both sides of the plate using the same milling tool.

After being cut from the metal plate, the shaped bodies are preferably smoothened and/or polished. This step is performed after closing of the shaped bodies, allowing removal of any steps or edges that may be caused, for example, by tolerances in a screw connection.

The shaped bodies obtained according to the present invention have a cavity formed by a blind hole and filled with a powder, with the blind hole reversibly sealed, for example by a screw cap, a stopper or a closing element made of a shape memory alloy.

The diameter of the shaped body is preferably one to several millimeters, more preferably 1 to 10 mm, even more preferably 1 to 5 mm and particularly preferably 1 to 3 mm. It is particularly preferred that the shaped body is ball-shaped. Shaped bodies with these dimensions are particularly suited for use in a known ball measuring system, for example with a measuring tube for balls with a diameter of 1.6 mm. Other known measuring systems require measuring balls with a diameter of 2.54 mm.

The diameter of the blind hole can be up to 80% of the diameter of the shaped body, with up to 80% of the largest diameter of the shaped body provided for the blind hole in the case of non-round shaped bodies.

The use of the shaped bodies according to the present invention allows the introduction of any material to be changed by neutron bombardment into the reactor core. In particular, the material can serve as a radionuclide precursor. Particularly, the radionuclides generated from the radionuclide precursor are selected from the following group: Ac-225, Ac-227, At-211, Bi-212, Bi-213, B-10, Cd-112, C-11, C-13, Cs-131, Cs-137, Cr-51, Co-57, Co-60, Cu-67, D-1, F-18, Ga-67, Ga-68, He-3, Ho-166, In-111, I-123, I-124, I-125, I-131, Ir-192, Li-7, Lu-177, Mo-99, Mo-100, Ne-22, N-13, N-15, O-15, O-18, Pd-103, P-32, P-33, Pb-211, Pb-212, Ra-223, Ra-224, Re-186, Re-188, Rb-82, Ru-106, Sm-153, Si-28, Sn-177m, Sr-88, Sr-89, Sr-90, S-35, Tc-99, Th-227, Tl-201, Tl-203, Tm-170, Ur-235, Xe-133, Yb-169, Yb-175, Y-90, Zn-64, Zn-68.

The radionuclide precursor is converted into the radionuclide by neutron bombardment, with the conversion performed either by neutron activation based on the same element or by any complex nuclear reaction. It is known to those skilled in the art which starting materials are suitable to generate the desired radionuclides.

For example, the powder can be an oxide, a phosphate, a carbonate, a sulfate or a chloride of the radionuclide precursor. It is also possible to use the element in its pure form. Advantageously, a material is used as a radionuclide precursor that can be easily processed to form a heat- and pressure-resistant powder to facilitate filling of the blind hole in the shaped body.

Preferably, the powder-filled shaped bodies are introduced into a ball measuring system for commercial nuclear power reactors and used for the generation of radionuclides, thus allowing easy generation of radionuclides of a variety of elements which can be used in industrial, scientific and medical applications. Ball measuring systems for neutron flux determination are present in numerous commercial nuclear power reactors. Without retrofitting, these can be utilized for the generation of radionuclides using the shaped bodies according to the present invention.

In contrast to research reactors designed for diverse applications, commercial nuclear power reactors have so far been used exclusively for the generation of electrical energy. By means of the method according to the present invention another application can be easily made available by using irradiation positions unexploited so far in the commercial nuclear power reactor without the need to intervene in the ongoing process of energy generation.

However, the shaped bodies manufactured according to the present invention cannot only be employed in commercial nuclear power reactors commercially utilized for energy generation, but also in research reactors.

In addition, the shaped bodies manufactured according to the present invention themselves can be used as probes to determine neutron flux density in a ball measuring system. To this end, the shaped bodies can be filled, for example, with a powder material that is not converted into a medically usable radionuclide, but has a high turnover rate for neutrons and, simultaneously, low radiation activity. From the turnover rate of this powder material the distribution of the neutron flux in the reactor core can be determined. This way, even a more precise power measurement can be achieved than with solid metallic balls.

For example, it is possible to use a compound containing cobalt-59 as a starting material to increase the sensitivity of neutron measurement. As the gamma emission line of the nuclide cobalt-60 formed is highly energetic, it can be well detected meteorologically. This means that comparatively low activation levels and thus smaller neutron fluxes can be measured as compared to the iron nuclides commonly used today.

The invention is subsequently described in detail by means of several exemplary embodiments with regard to the attached drawings. In the drawings:

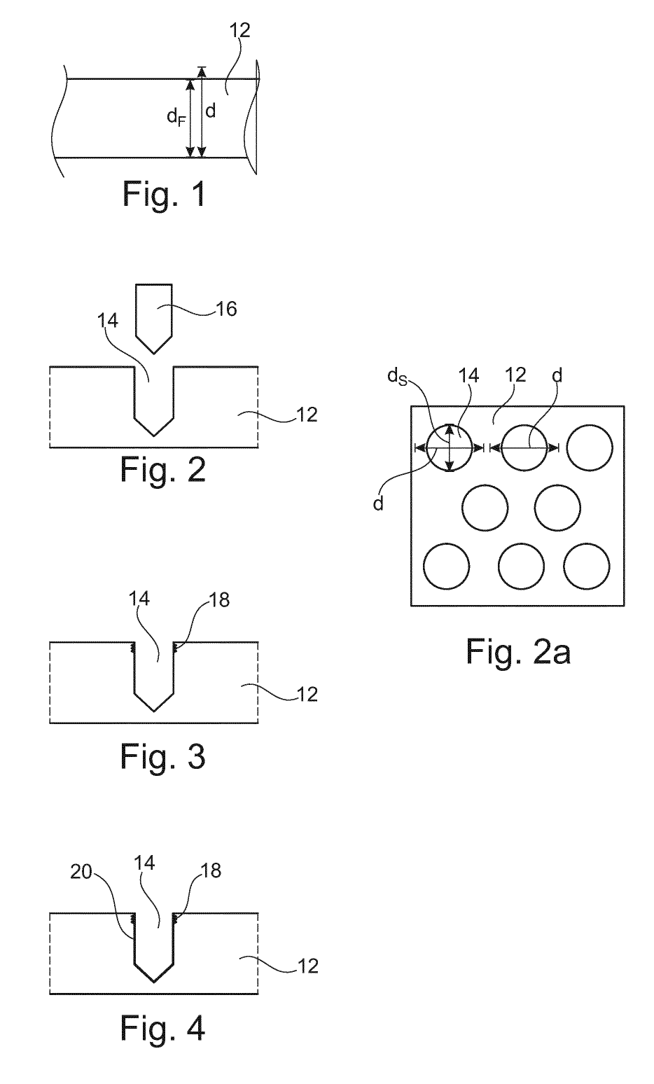

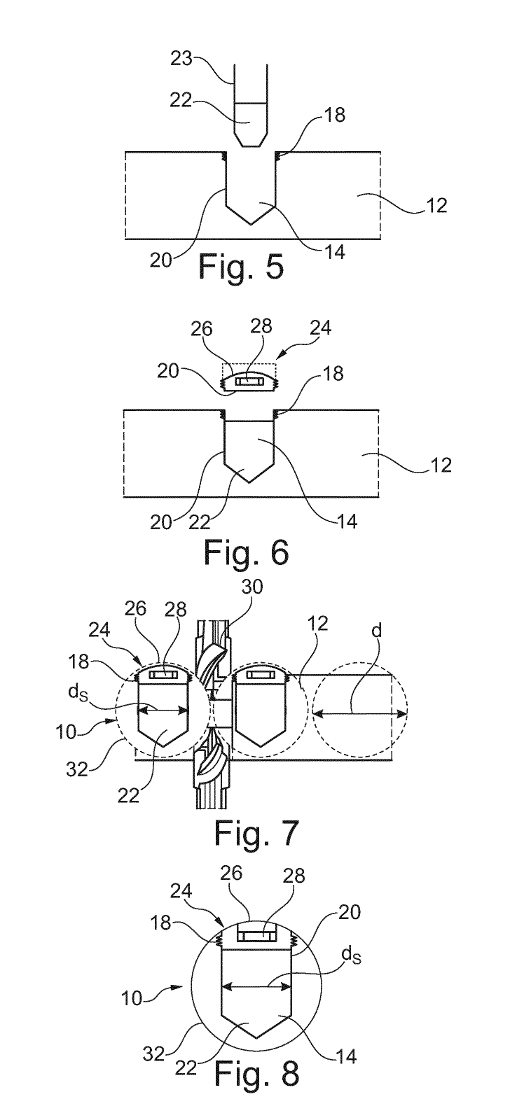

FIGS. 1 to 8 schematically show manufacturing steps for the manufacture of powder-filled shaped bodies according to the present invention in accordance with a first embodiment;

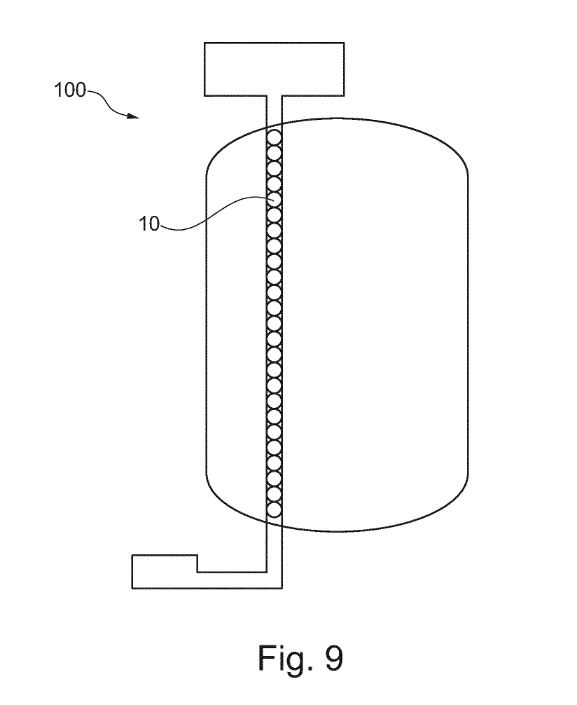

FIG. 9 schematically shows the use according to the present invention of the shaped bodies according to the present invention in a ball measuring system of a power reactor;

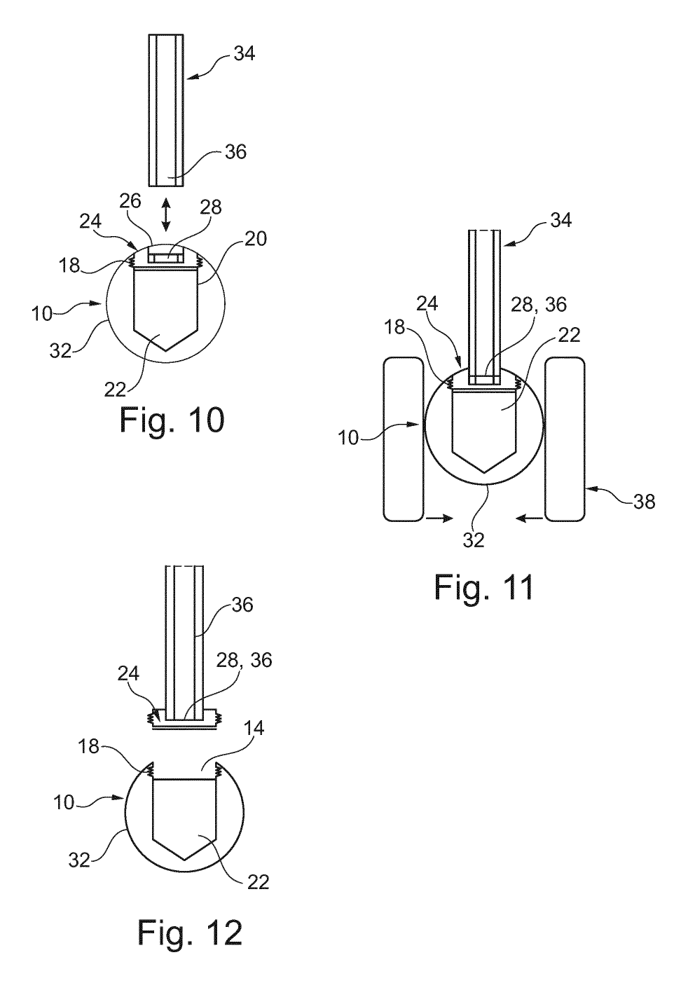

FIGS. 10 to 12 schematically show steps to remove the powder from a shaped body in accordance with the first embodiment;

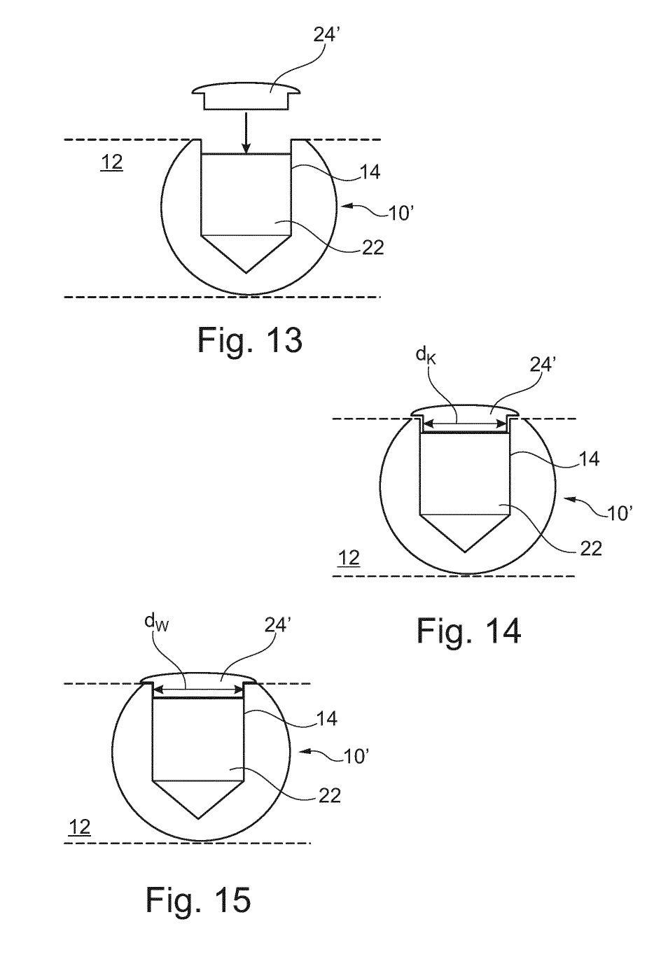

FIGS. 13 to 15 schematically show steps to seal a shaped body according to the present invention in accordance with a second embodiment; and

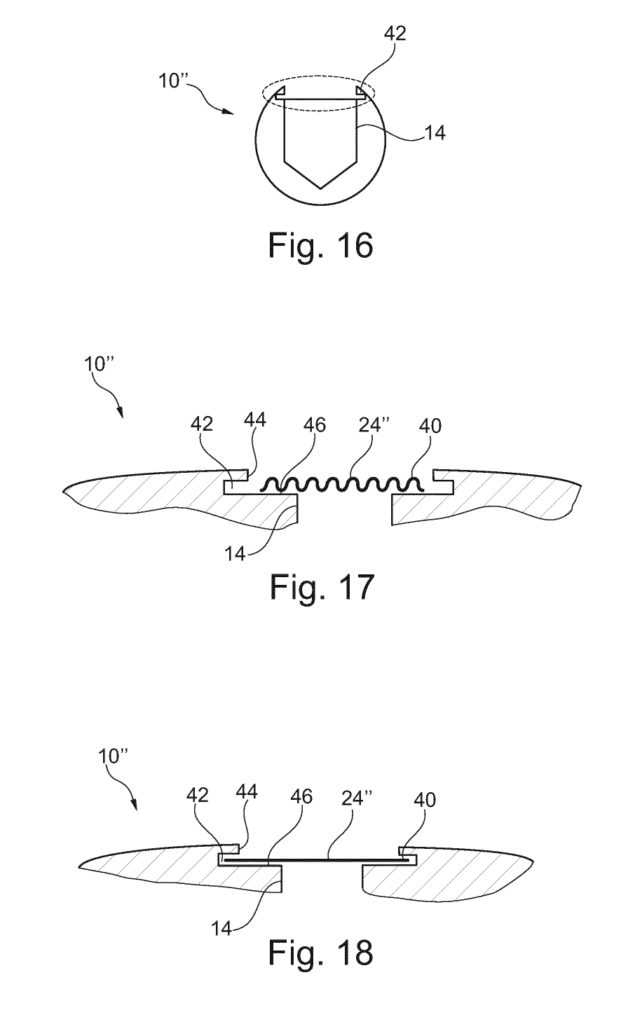

FIGS. 16 to 18 schematically show steps to seal a shaped body according to the present invention in accordance with a third embodiment.

FIGS. 1 to 8 show the manufacture of a powder-filled shaped body 10 (see FIGS. 7 and 8) in a first embodiment.

First, a plate 12 made of a suitable metal or metalloid is provided.

In the embodiment shown here, the thickness d_{F} of the plate 12 is selected to be slightly smaller than the desired diameter d of the subsequent shaped body 10; however, it can also be selected to be slightly larger.

The material of the plate 12 is selected so that it is as permeable as possible for neutrons, i.e. exhibits low neutron absorption. In addition, it should have a certain hardness and a good temperature and pressure stability for temperatures of up to 400° C. or more. For example, the plate 12 can be formed of high-grade steel, chrome steel, carbon steel, heat-treated carbon steel, zirconium, silicon, magnesium, aluminum, molybdenum as well as alloys or mixtures based on these materials. Carbon, nitrogen, boron or phosphorus as well as other metals such as calcium can be present as further alloying elements in common proportions.

A number of blind holes 14 spaced apart from each other are drilled into the plate 12 by means of a suitable drill 16 or by use of laser beams or water jets. Preferably, the blind holes 14 have a concave bottom.

In the embodiment shown, the blind holes 14 are arranged in a hexagonal pattern of blind holes 14, with the centers of the individual blind holes 14 spaced apart by a little more than the desired diameter d (see FIG. 2a). Preferably, the diameter d_{S} of the blind hole 14 is approximately 70-80% of the diameter d of the finished shaped body 10.

Each of the blind holes 14 is provided with an internal thread 18 comprising one or more turns at its open end.

According to a preferred embodiment, a thin coating 20 is then applied in the region of the blind holes 14 or the entire plate completely lining the interior of the blind hole 14. The coating 20 is selected from a material that is inert towards the plate 12 and the powder material to be filled into the blind holes 14 and is pressure and temperature resistant.

Preferably, the plate 12 is formed of aluminum or an aluminum alloy. In this case, the coating 20 of the blind holes 14 is preferably generated by anodizing or hard anodizing, with a layer thickness of about 8-20 μm. Anodizing is performed while the shaped bodies 10 are still linked with each other via the plate 12.

As a possible alternative to produce the coating 20, a sol-gel dispersion of silicon dioxide or water glass can be used, which is heated after application forming a glass-like, thin and chemically stable silicate layer on the surface of the blind holes.

In general, especially oxides such as silicon oxide, titanium oxide, aluminum oxide and zirconium oxide or silicates such as an alkali aluminum mixed silicate, but also similar inorganic substances showing an inert, glass-like behavior at high temperatures can be used as a material for the coating 20. For example, the coating 20 can be produced by deposition from the gas phase or by means of a PVD process or by sputtering. Layer thickness is preferably selected to be less than 20 μm and is preferably in the range of approximately 5 to 20 μm. Layer thicknesses of more than 20 μm may lead to embrittlement and spalling off and are thus not desired.

The blind hole 14 prepared this way is filled with a pre-determined quantity of a powder 22. For example, traditional automated dosing devices with known series micropipettes 23 known from pharmaceutical technology (not described in detail herein) can be used for filling the blind holes 14.

Each of the blind holes 14 filled with the powder 22 is sealed by a closing element 24, here in the form of a screw, that is screwed in the internal thread 18. The blind hole 14 is sealed against its surrounding by the screw screwed in.

In a preferred variant the internal thread 18 is a taper thread and the screw is a taper screw.

A possible embodiment for the manufacture of a ball-shaped shaped body with an external diameter of 1.6 mm comprises the arrangement of blind holes 14 in a hexagonal pattern in the upper surface of the plate 12 by drilling, with the blind holes 14 having an internal diameter of 1.2 mm. As a result of the conical design of the drill bit the bottom of the blind holes assumes a concave shape, with the lower apex of the bottom of the blind holes being at a distance of about 0.2 mm from the lower surface of the plate. The edge of the taper at the bottom of the blind holes may have a distance of 0.2 mm to the subsequent outer edge of the ball. At the upper edge, each blind hole 14 can be provided with a fine taper thread having a slope of 0.1 mm, extending to a depth of 0.2 mm. The lower edge of the taper thread can be at a distance of 0.376 mm from the upper edge of the plate 12. The lower edge of the thread may have a diameter of 1.20 mm, the upper edge of the thread may be about 0.2 mm larger. Using such a thread, the interior of the balls formed can be safely, reversibly and tightly sealed with a taper screw using barely 4 turns. The taper screw safely seals the blind hole 14.

The inner surface of the screw can be formed as a concave curvature to increase the amount of powder 22 that can be filled into the blind hole 14.

Optionally, the bottom of the screw that comes into contact with the powder 22 can also be provided with a coating 20, thus excluding contamination of the powder 22.

The outer contour 26 of the screw head can already have the desired subsequent outer contour of the shaped body 10. However, the screw head can also be finished in the next step.

The screw head exhibits an engagement geometry 28, for example in the form of a hexagon socket, a cross recess or a simple slot where the screw can be screwed in the internal thread 18 and later be removed from it.

According to a preferred embodiment, the screw is made of a magnetic material.

In the next procedural step the plate 12 is cut, for example by means of a milling tool 30 or another suitable automated method, with the shaped bodies 10 carved out of the material, thus obtaining their desired outer contour 32. In this example, the outer contour 32 is ball-shaped, although, for example, it could also have the form of ellipsoids, lenses and discs. In this procedural step the contour 26 of the screw head can also be processed so that it fits into the desired outer contour 32 of the shaped body 10.

Subsequently, the finished powder-filled shaped bodies 10 can be smoothened and polished.

When using the shaped bodies 10 to generate radionuclides, the shaped bodies 10 are introduced into a known ball measuring system 100 of a commercial nuclear power reactor (schematically shown in FIG. 9) and exposed to the neutron flux in the core of the reactor for a pre-determined period of time.

In this case, the powder 22 filled into the blind holes 14 contains radionuclide precursors that are at least partially converted into the desired radionuclide by neutron bombardment. Examples of radionuclides obtainable by means of this method are: Ac-225, Ac-227, At-211, Bi-212, Bi-213, B-10, Cd-112, C-11, C-13, Cs-131, Cs-137, Cr-51, Co-57, Co-60, Cu-67, D-1, F-18, Ga-67, Ga-68, He-3, Ho-166, In-111, I-123, I-124, I-125, I-131, Ir-192, Li-7, Lu-177, Mo-99, Mo-100, Ne-22, N-13, N-15, O-15, O-18, Pd-103, P-32, P-33, Pb-211, Pb-212, Ra-223, Ra-224, Re-186, Re-188, Rb-82, Ru-106, Sm-153, Si-28, Sn-177m, Sr-88, Sr-89, Sr-90, S-35, Tc-99, Th-227, Tl-201, Tl-203, Tm-170, Ur-235, Xe-133, Yb-169, Yb-175, Y-90, Zn-64 or Zn-68.

Conversion of the radionuclide precursor into the desired target radionuclide is performed by neutron capture, for example by simple neutron activation based on the same element, as for example in the case of molybdenum-99:

⁹⁸Mo (n, γ) ⁹⁹Mo.

Alternatively, conversion is based on another element and the desired target nuclide is generated by any complex nuclear reaction, as for example in the case of lutetium-177:

¹⁷⁶Yb (n, γ) ¹⁷⁷Yb (-, β) ¹⁷⁷Lu.

To provide a powder 22 to be filled into the shaped bodies 10 which is easy to process, free-flowing, chemically inert towards oxygen and thermally stable, the radionuclide precursors are used, for example, as an oxide, phosphate, carbonate, sulfate of chloride of the respective elements. The radionuclide precursor can also be used in the form of the pure element if the substance used can be pulverized as a pure element.

After expiry of the specified irradiation period in the reactor core the shaped bodies 10 are removed from the ball measuring system 100 and transferred into a suitable tool to obtain the powdery radionuclide, which can be performed in a familiar way by means of compressed air or the effect of gravity.

In this embodiment, the tool used to obtain the powdery radionuclide from the shaped bodies 10 is preferably a magnetic tool 34 the head 36 of which is adjusted to the engagement geometry 28 of the screw.

The tool 34 magnetically attracts one shaped body 10 at a time, with the tool head 36 engaging into the engagement geometry 28 of the screw. Now the shaped body 10 is fixed by a suitable tool equipped with two gripper jaws 38 (see FIG. 11) and the screw is screwed out (see FIG. 12) so that the desired radionuclide, as a powder 22, is accessible in the interior of the blind hole 14 of the shaped body 10 and can be gathered in a collection device (not shown).

A second preferred embodiment for the manufacture of shaped bodies 10′ is shown in FIGS. 13 to 15. In contrast to the first embodiment, here the closing element 24′ sealing the blind hole 14 is a stopper. The stopper is clamped to the inner wall of the blind hole 14 and hermetically seals the blind hole 14 towards the outside.

In this example materials with different coefficients of thermal expansion are used for the stopper and the plate 12, with the material of the stopper preferably having a larger coefficient of thermal expansion than the material of the plate.

To seal the blind holes 14 the stoppers and the plate 12 are cooled, e.g. by using liquid nitrogen, reducing the diameter of the stopper to a value d_{K} that is smaller than the diameter d_{S} of the blind hole 14 in the cooled-down state (see FIG. 14). In this state, the stoppers are inserted into the blind holes 14.

When heated to room temperature or a higher temperature the stoppers again expand to such an extent that their diameter assumes a value d_{W} corresponding to the diameter of the blind hole d_{S} or are selected to be slightly larger for the stopper to brace in the blind hole 14 and tightly seal it.

Like in the first embodiment, the step of filling and closing the blind holes 14 is performed during the manufacture of the shaped bodies 10′ while these are still connected by the material of the plate 12.

To remove the stopper from the blind holes 14 following exposition of the shaped bodies to neutron irradiation in the reactor core the shaped bodies 10′ collected are cooled down and shaken in a drum (not shown), with the clamped connection between the stopper and the blind holes 14 coming loose again. The stoppers, together with the powder 22, are shaken out of the blind holes 14 and can be separated from the powder 22 using a screen.

The blind holes 14 can have a slightly larger diameter in the section of their upper edge than in their lower section; however, the diameter of the stoppers is adjusted to this section (not shown).

In a third preferred embodiment for the manufacture of shaped bodies 10″ shown in FIGS. 16 to 18 the blind hole 14 is sealed by a closing element 24″ made of a shape memory alloy with a 2-way memory effect.

The closing element 24″ has a first state in which is can be loosened from the blind hole 14 and which it assumes at a first, low temperature. The first temperature, for example, can be about 10° C. or less.

In FIG. 17 the closing element 24″ is shown in its first state. Preferably, the closing element 24″ is a flat metal sheet with a square peripheral edge 40 and exhibits several parallel corrugations in its first state. However, the closing element can also have another shape and/or another outer contour.

The closing element 24″ has a second state in which it tightly seals the blind hole 14 and which it assumes at a second, higher temperature of about 40-50° C. and exceeding temperatures as they are achieved in the reactor core. Preferably, the second temperature is about 30-40 K above the first temperature.

In its second state the closing element 24″ has a larger expansion than in its first state, as can be seen in FIG. 18. In this example, the corrugations on the surface of the closing element 24″ expand during transition to the second state resulting in an increased diameter or surface area of the closing element 24″.

In the embodiment shown here a square, circumferential, radial groove 42 is formed in the upper section of the blind hole 14 whose axially outer edge 44 is slightly set back as compared to the axially inner edge 46.

In the first state the expansion of the closing element 24″ is so small that the peripheral edge 40 of the closing element 24″ can pass the outer edge 44 of the groove 42 and be placed on the inner edge 46 of the groove 42 (see FIG. 17). To seal the blind hole 14 the tailor-made closing element 24″ is thus cooled down to such an extent that it again assumes its first state and is supported by the edge 46 of the groove 42.

When heated to the second temperature the peripheral edge 40 of the closing element 24″ slides into the groove 42 and thus fixes the closing element 24″ at the body of the shaped body 10″, tightly sealing the blind hole 14 (see FIG. 18).

To remove the powder 22 from the shaped bodies 10″ following irradiation in the reactor core the shaped bodies are cooled down to the first temperature at which the closing elements 24″ again assume their first state and can be loosened from the blind holes 14.

As described above, the powder 22 can be separated from the shaped bodies 10″ and the detached closing elements 24″ in a drum.

Apart from the kind of closing element 24′, 24″, the shaped bodies 10′, 10″ used for the second and third embodiment correspond to the shaped bodies 10 described in the first embodiment. The other steps of the manufacturing process are also identical. As in the first embodiment it is, for example, possible to provide the side of the closing element 24′, 24″ directed to the blind hole 14 with a coating 20.

The radionuclides obtained this way are preferably used in medical, scientific or industrial applications generally known to those skilled in the art.

Alternatively, it is also conceivable to use the generated radionuclides to determine a very precise position-dependent neutron density in the reactor core by means of the ball measuring system 100. To this end, the shaped bodies employed as measuring probes and/or the individual powder lots are fed into a basically known detector device where the activity of the powder lots is determined.

1. A method for the manufacture of shaped bodies filled with a powder for introduction into a reactor core of a commercial nuclear power reactor, wherein
a plate made of a metal and/or metalloid is provided with one or more blind holes,
the blind holes are filled with powder,
the blind holes filled with powder are reversibly sealed,
shaped bodies are cut from the plate so that each blind hole filled with powder (22) is surrounded by a shell formed of a metal and/or metalloid.

2. The method according to claim 1, wherein the shaped bodies are provided with a ball-shaped outer contour.

3. The method according to claim 1, wherein the blind holes are drilled.

4. The method according to claim 1, wherein the blind holes (14) are incorporated into the plate in a hexagonal arrangement.

5. The method according to claim 1, wherein the blind holes, prior to being filled with powder, are provided with a chemically inert coating.

6. The method according to claim 1, wherein the blind holes are provided with an internal thread.

7. The method according to claim 1, wherein the blind holes are sealed with a closing element in the form of a screw.

8. The method according to claim 1, wherein the blind holes are sealed with a closing element in the form of a stopper which is clamped to a wall of the blind hole.

9. The method according to claim 8, wherein the stopper and the plate are formed of materials with different coefficients of thermal expansion.

10. The method according to claim 1, wherein the blind hole is sealed by a closing element made of a shape memory alloy which has a first state in which it can be loosened from the blind hole and a second state in which is seals the blind hole.

11. The method according to claim 10, wherein the closing element is inserted into a radial groove running along the peripheral edge of the blind hole.

12. The method according to claim 1, wherein the shaped bodies after being cut from the plate are smoothened and/or polished.

13. A shaped body for introduction into a reactor core of a commercial nuclear power reactor, obtained by a method according to claim 1, wherein the shaped body has a cavity formed by a blind hole and filled with a powder, with the blind hole reversibly sealed.

14. The shaped body according to claim 13, wherein the blind hole has a concave bottom.

15. The shaped body according to claim 13, wherein the diameter (d) of the shaped body is 1 to 10 mm.

16. The shaped body according to claim 13, wherein the diameter (dS) of the blind hole is up to 80% of the diameter (d) of the shaped body.

17. The shaped body according to claim 13, wherein the powder is a radionuclide precursor that can be converted into a radionuclide by neutron radiation, selected from the group consisting of Ac-225, Ac-227, At-211, Bi-212, Bi-213, B-10, Cd-112, C-11, C-13, Cs-131, Cs-137, Cr-51, Co-57, Co-60, Cu-67, D-1, F-18, Ga-67, Ga-68, He-3, Ho-166, In-111, I-123, I-124, I-125, I-131, Ir-192, Li-7, Lu-177, Mo-99, Mo-100, Ne-22, N-13, N-15, O-15, O-18, Pd-103, P-32, P-33, Pb-211, Pb-212, Ra-223, Ra-224, Re-186, Re-188, Rb-82, Ru-106, Sm-153, Si-28, Sn-177m, Sr-88, Sr-89, Sr-90, S-35, Tc-99, Th-227, Tl-201, Tl-203, Tm-170, Ur-235, Xe-133, Yb-169, Yb-175, Y-90, Zn-64, Zn-68.

18. The shaped body according to claim 17, wherein the powder is an oxide, phosphate, carbonate, sulfate or chloride of the radionuclide precursor.

19. The shaped body according to claim 13, wherein the plate is made of a material selected from the group consisting of high-grade steel, chrome steel, carbon steel, heat-treated carbon steel, zirconium, silicon, magnesium, aluminum, molybdenum or an alloy or mixture based on one or more of these materials with each other and/or with carbon, nitrogen, boron and phosphorus.

20-21. (canceled)

22. A method for the generation of radionuclides in a reactor core of a nuclear power reactor, the method comprising introduction of powder-filled shaped bodies according to claim 13, wherein the powder is a radionuclide precursor that can be converted into a radionuclide by neutron radiation, into a reactor core of a nuclear power reactor and exposed to neutron flux for a period of time, after which the powder-filled shaped bodies are removed from the reactor core.

23. The method according to claim 22 for measuring neutron flux density in the reactor core of a nuclear power reactor, wherein the powder-filled shaped bodies are introduced into a ball measuring system of a nuclear power reactor, and after exposure to neutron flux for a fixed period of time the powder-filled shaped bodies are removed from the reactor core and the activation level of the powder is measured.
